(19) United States
(12) Patent Application Publication
(10) Pub. No.: US 2003/0053521 A1
(43) Pub. Date: Mar. 20, 2003

(54) System and electronic device for providing a multi-carrier spread spectrum signal

(76) Inventors: Xiaojing Huang, Waverton (AU); Yunxin Li, Ryde (AU)

Correspondence Address: MOTOROLA, INC., 1303 EAST ALGONQUIN ROAD, IL01/3RD, SCHAUMBURG, IL, 60196

(21) Appl. No.: 09/953,798

(22) Filed: Sep. 17, 2001

(51) Int. Cl. H04L 27/30

(52) U.S. Cl. 375/144; 375/146; 375/148

(57) ABSTRACT

An electronic device (100) for providing a multi-carrier spread spectrum signal. The device (100) has a spread spectrum signal encoder (140) and decoder (160). The encoder has sequence spreading modules (143) and modulators (145) each having a unique carrier frequency relative to all other carrier frequencies of the other modulators (145). The encoder (140) converts a received serial data stream of bits into a plurality of parallel data bit streams of different bit lengths, and expand a received one of the parallel data bit streams into a coded bit sequences. Each of the coded bit sequences have a unique time period relative to all other said coded bit sequence from every other sequence spreading modules (143) of the encoders (140). The decoder (160) decodes received multi-carrier spread spectrum signals into data bit streams.

### FIELD OF THE INVENTION

This invention relates to a spread spectrum system and an electronic device for providing a multi-carrier spread spectrum signal. The invention is particularly useful for, but not necessarily limited to, systems and devices with radio frequency communication links.

### BACKGROUND OF THE INVENTION

Spread Spectrum (SS) technologies have been used for anti-jamming and security communications systems as well as commercial cellular and other wireless communications networks. Recently, an unconventional form of SS technology, namely ultra-wideband (UWB) technology, has attracted a great deal of attention because of its unique advantages over other conventional SS systems. One of the most important characteristics of the UWB signals is that their bandwidths could be orders of magnitude more than that of the conventional SS systems. Due to their ultra-wide bandwidth, UWB signals demonstrate unique properties such as high time-resolution and deep materials penetration. UWB technology may enable the realisation of exceptionally high performance, low cost wireless communications systems with improved capacity. These UWB systems include wireless cable replacement devices, ultra-high speed Local Area Networks (LANs), and ultra-low power wireless links for Personal Area Networks (PANs).

A major concern of UWB communication systems is that they could potentially interfere with existing communications systems because the emission bandwidth of UWB devices generally exceeds one Gigahertz (GHz) and may be greater than ten GHz. UWB communications systems usually use time-hopped or biphase modulated impulse trains to carry information and are therefore sometimes called impulse radio. The advantage of the impulse radio is that it is easy to generate UWB signal with broad bandwidth by just emitting a series of impulses with very short pulse duration, as the bandwidth of an impulse signal is inversely proportional to the pulse duration. For example, an impulse with duration of one Nanosecond could have a bandwidth of one GHz. However, there are also disadvantages associated with the impulse radio.

Firstly, the spectrum of the UWB signal generated by impulse radio is very hard to control. This is because the bandwidth is inversely proportional to the pulse duration and the bandwidth inherently fixed at around zero Hertz. As a result, the impulse radio is very likely to interfere with existing narrowband systems.

Secondly, to receive and decode the transmitted information, the impulse radio uses the received UWB signal to perform cross-correlation with the known reference impulse train directly in the time domain. Because the impulse duration is very short, cross-correlation is effected by an analogue device and thus the performance can be unsatisfactory.

Thirdly, for a high data rate UWB system, the impulse radio cannot efficiently mitigate the adverse effects of the multi-path reflections of the UWB signal that unfortunately cause increased error rates.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided an electronic device for providing a multi-carrier spread spectrum signal, the device comprising:

a serial to parallel converter;

a plurality sequence spreading modules each with an input coupled to a respective output of the serial to parallel converter;

a plurality of modulators each being coupled to an output of a respective one of the sequence spreading modules and each of the modulators having a unique carrier frequency relative to all other carrier frequencies of the other modulators; and

an output unit coupled to the modulators, wherein, in use, the serial to parallel converter converts a received serial data stream of bits into a plurality of parallel data bit streams of different bit lengths, and the sequence spreading modules expand a received one of the parallel data bit streams into a coded bit sequence, and wherein the coded bit sequence from each of the sequence spreading modules have a unique time period relative to the coded bit sequence from every other of the sequence spreading modules.

Suitably, the electronic device may include a combiner coupling the modulators to the output unit, the combiner having inputs coupled to a respective output of each of the modulators, wherein an output of the combiner provides the multi-carrier spread spectrum signal that is a combination of the coded bit sequence.

Suitably, each of the sequence spreading modules may code a plurality of consecutively received the data bits of a respective one of the parallel data bit streams into an interleaved spread spectrum signal.

Preferably, each of the sequence spreading modules codes the consecutively received data bits by a code sequence having a bit code associated with each of the received data bits, wherein any bit code pair of the coded sequence when cross correlated is zero.

Preferably, each of the sequence spreading modules may provide a bit time period that is unique relative to bit time periods provided by the other sequence spreading modules.

Suitably, one of the sequence spreading modules may provide a base bit time period, wherein all other sequence spreading modules provide a bit time period that is an integer multiple of the base time period.

Preferably, each interleaved spread spectrum signal from each of the sequence spreading modules can have a unique number of bits relative to the interleaved spread spectrum signal from the other sequence spreading modules, wherein the number of unique bits multiplied by the associated bit time period for each of the sequence spreading modules results in identical coded sequence time durations.

The electronic device may also include an input unit coupled to a spectrum signal decoder, wherein the spectrum signal decoder decodes a received multi-carrier spread spectrum signals received at the input unit to provide a decoded bit stream.

Suitablty, the decoder may include:

a plurality of demodulators each coupled to respective despreading modules;

wherein, in use, the despreading modules decode the received multi-carrier spread spectrum signals into the decoded bit stream.

Preferably, the spectrum signal decoder may suitably include a parallel to serial converter coupled to respective outputs of the despreading modules.

Suitably, the output unit may include a radio transmitter.

The output unit may include a modem. Preferably, the output unit may provide for connection and transmission of the multi-carrier spread spectrum signal to a wired communication link.

The electronic device may be a radio communication device such as a two-way radio communication device and the digital signal providing circuitry may be coupled to a microphone. Typically, the signal providing circuitry may preferably includes a digital data store.

According to another aspect of the invention there is provided a multi-carrier spread spectrum signal communication system comprising: a communication link; and a plurality of electronic devices in communication with each other by the communication link, the electronic devices comprising:

a serial to parallel converter;

a plurality sequence spreading modules each with an input coupled to a respective output of the serial to parallel converter;

a plurality of modulators each being coupled to an output of a respective one of the sequence spreading modules and each of the modulators having a unique carrier frequency relative to all other carrier frequencies of the other the modulators; and

an output unit coupled to the modulators, wherein, in use, the serial to parallel converter converts a received serial data stream of bits into a plurality of parallel data bit streams of different bit lengths, and the sequence spreading modules expand a received one of the parallel data bit streams into a coded bit sequence, and wherein the coded bit sequence from each of the sequence spreading modules have a unique time period relative to the coded bit sequence from every other of the sequence spreading modules.

The electronic device of the spread spectrum signal communication system may suitably include any or all of the above elements or functions.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a schematic block diagram of an electronic device for providing a multi-carrier spread spectrum signal in accordance with the invention;

FIG. 2 is a schematic block diagram of a spread spectrum signal encoder comprising part of the electronic device of FIG. 1;

FIG. 3 is a schematic block diagram of a spread spectrum signal decoder comprising part of the electronic device of FIG. 1;

FIG. 4 is a schematic block diagram of a serial to parallel converter comprising part of the spread spectrum signal encoder of FIG. 2;

FIG. 5 is a schematic block diagram of parallel to serial converter comprising part of the spread spectrum signal decoder of FIG. 3;

FIG. 6 is a schematic block diagram of a sequence spreading module comprising part of the spread spectrum signal encoder of FIG. 2;

FIG. 7 is a schematic block diagram of a sequence despreading module comprising part of the spread spectrum signal decoder of FIG. 3; and

FIG. 8 is a schematic block diagram of a spread spectrum signal communication system.

### DETAILED DESCRIPTION OF A PREFERRED EMBODIMENT OF THE INVENTION

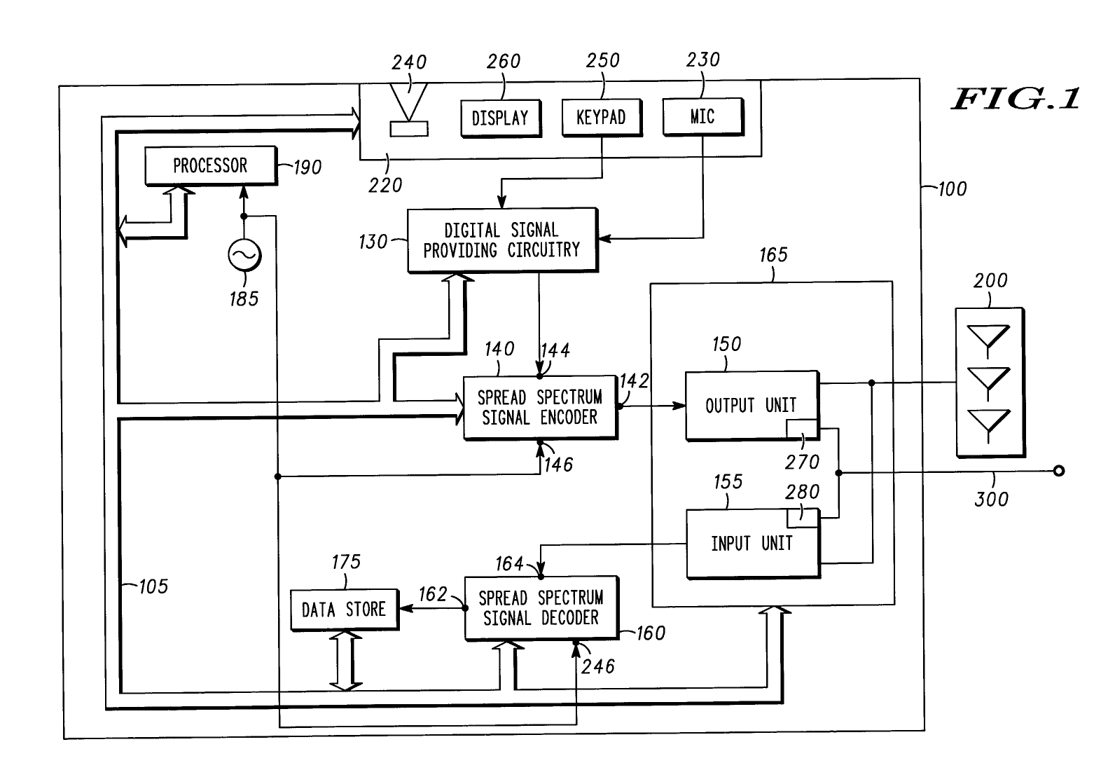

Referring to FIG. 1 there is illustrated a schematic block diagram of an electronic device 100 for providing a multi-carrier spread spectrum signal. The electronic device 100 is typically a single or two way radio communication device, it may also form part of a computer or other processing unit coupled to a network by a wired communication link or radio link. The electronic device 100 includes a spread spectrum signal encoder 140 and a digital signal providing circuitry 130 coupled to a signal input 144 of spread spectrum signal encoder 140. There is also an output unit 150 coupled to an output 142 of spread spectrum signal encoder 140.

The electronic device 100 also includes a spread spectrum signal decoder 160 with an input 164 coupled to an input unit 155 by a buffer (not illustrated) that forms part of input unit 155. An output 162 of the spread spectrum signal decoder 160 is coupled to a digital data store 175. In order to provide synchronization, the electronic device 100 includes a clock 185 coupled to a processor 190 (with associated memory not shown), an input 146 of spread spectrum signal encoder 140 and an input 246 of spread spectrum signal decoder 160. The output unit 150 includes a radio transmitter coupled to a common antenna array 200. The input unit 155 includes a radio receiver coupled to the common antenna array 200. The output unit 150 and input unit 155 form part of a communication port 165. Further, a transmitter modem 270 forms part of output unit 150 and a receiver modem 280 forms part of input unit 155. Alternatively, output unit 150 and input unit 155 may be compatible for direct network connection (by a wired communication link or otherwise), and provide an Ethernet port at a port node 300 of the communication port 165.

There is also a user interface 220 having, in one embodiment, a microphone 230, a speaker 240, an input command or data device, typically in the form of a interactive display screen or keypad 250, and an optional display screen 260. The microphone 230 and keypad 250 are coupled to the digital providing circuitry 130. A combined data and address bus 105 couples processor 190 to the user interface 220, the spread spectrum signal encoder 140, the spread spectrum signal decoder 160, the digital providing circuitry 130, the data store 175 and the communication port 165.

As will be apparent to a person skilled in the art, the digital signal providing circuitry 130 is a memory buffer for storing digitised speech, text or data. Similarly, the data store 175 is a memory for storing received data or information received by the input unit 155 and decoded by decoder 160. The stored received data or information is subsequently accessed by the processor 190 or it may be sent to the speaker 240 (after processing) or display screen 260.

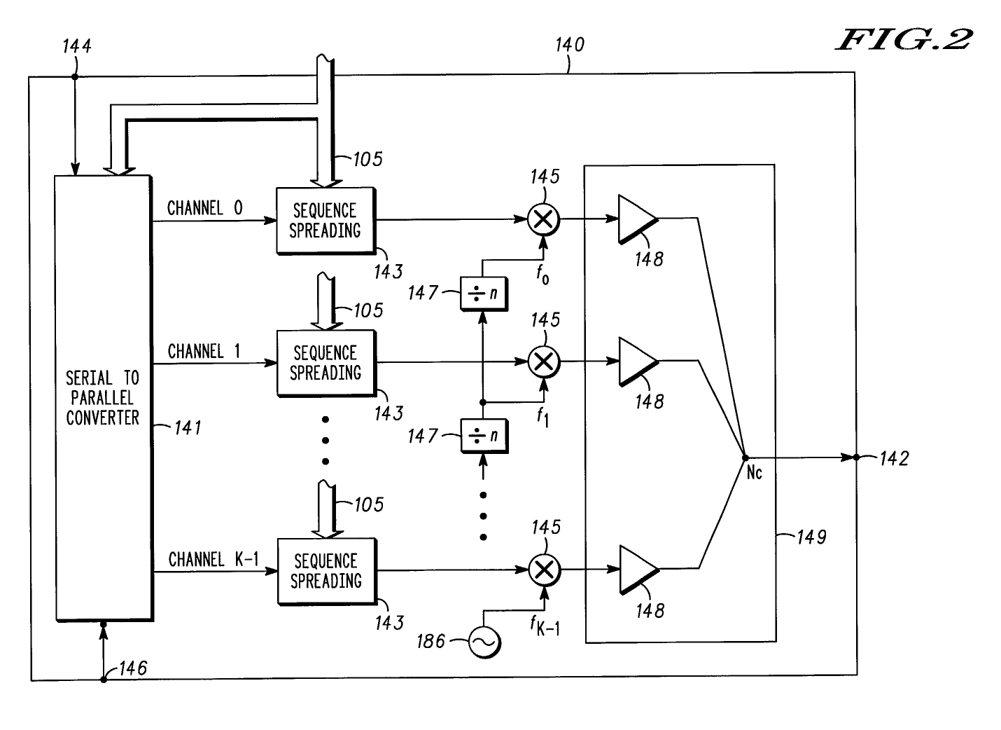

Referring to FIG. 2 there is illustrated a schematic block diagram of the spread spectrum signal encoder 140 comprising a serial to parallel converter 141 with K output channels (Channel 0 to Channel K−1) and an input provided by signal input 144. The K output channels are coupled to a respective one of a plurality sequence spreading modules 143 and the bus 105 is coupled to both the serial to parallel converter 141 and sequence spreading modules 143. There is also a plurality of modulators 145 each being coupled to an output of a respective one of the sequence spreading modules 143. The input 146 of spread spectrum signal encoder 140 provides a clock signal input to the serial to parallel converter 141. An oscillator 186 provides a modulation carrier frequency fₖ₋₁ to the modulator 145 associated with Channel K−1. Further, the other modulators 145 associated with Channels K-2 to Channel 0 each have a carrier frequency input coupled to the oscillator 186 by cascaded frequency dividing circuitry 147. Accordingly, each of the modulators 145 have a unique carrier frequency relative to all other carrier frequencies of the other modulators 145. The modulators are coupled to the output unit 150 at the output 142 by a combiner 149 comprising respective buffering amplifiers 148 with outputs connected together at a common node Nc. From the common node Nc, there is provided at an output of the combiner 149 a combination of a modulated spread spectrum signal from each of the modulators 145.

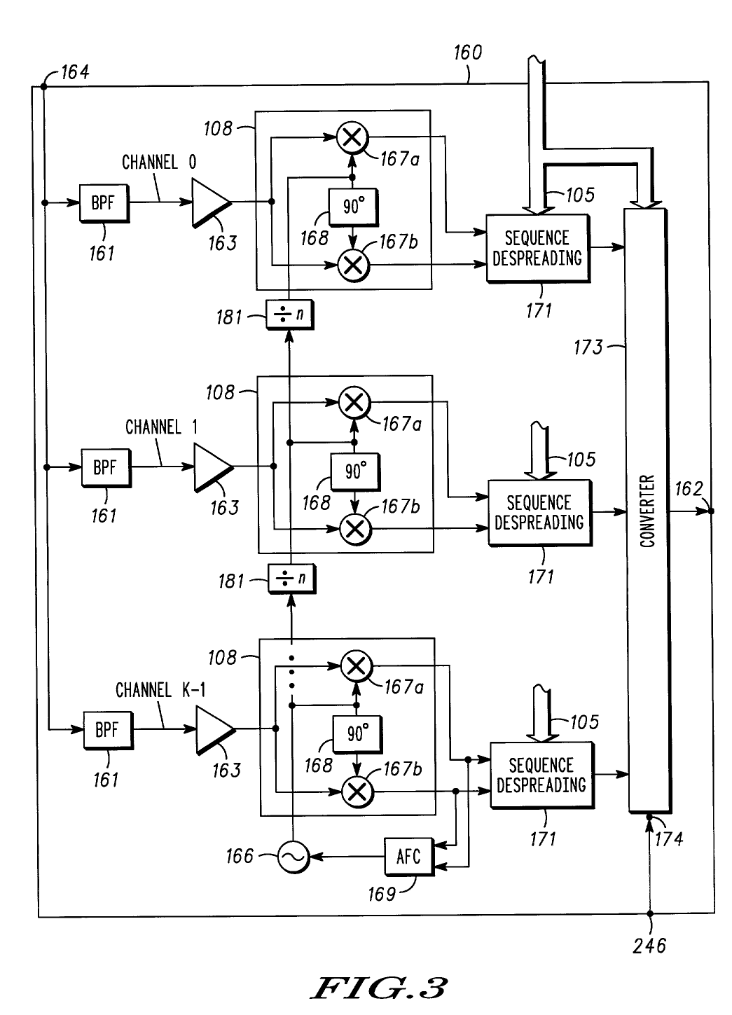

Referring to FIG. 3 there is illustrated a schematic block diagram of the a spread spectrum signal decoder 160 comprising a plurality of band pass filters 161 each having an input coupled to the input 164. Outputs of the band pass filters 161 provide modulated spread spectrum signal channel inputs to respective amplifiers 163 that have outputs coupled to respective IQ demodulators 108. Each of the IQ demodulators 108 comprise real and imaginary demodulators 167a, 167b with real and imaginary outputs coupled to a respective despreading module 171. Each despreading module is coupled to bus 105. Outputs of each despreading module 171 are coupled to a parallel to serial converter 173 with an output coupled to a data store 175 via the output 162. The input 246 of spread spectrum signal decoder 160 provides a clock signal to a clock signal input 174 to serial to parallel converter 173

The spread spectrum signal decoder 160 has an oscillator 166 with an output providing a demodulation carrier frequency fₖ₋₁ to the IQ demodulator 108 associated with channel K−1. Further, the other demodulators 108 associated with Channels K-2 to Channel 0 each have a carrier frequency input coupled to the oscillator 166 by cascaded frequency dividing circuitry 181. Accordingly, each of the IQ demodulators 108 has a unique demodulation carrier frequency relative to all other demodulation carrier frequencies of the other IQ demodulators 108. Further the IQ demodulators 108 have a 90 degree phase shift circuit 168 for providing an out of phase quadrature demodulation carrier frequency to the imaginary demodulators 167b relative to the carrier frequency provided to the associated in phase demodulator 167a. The real and imaginary outputs from the IQ demodulator 108 of Channel K−1 are fed to an Automatic Frequency Controller 169 that provides a control signal to oscillator 166.

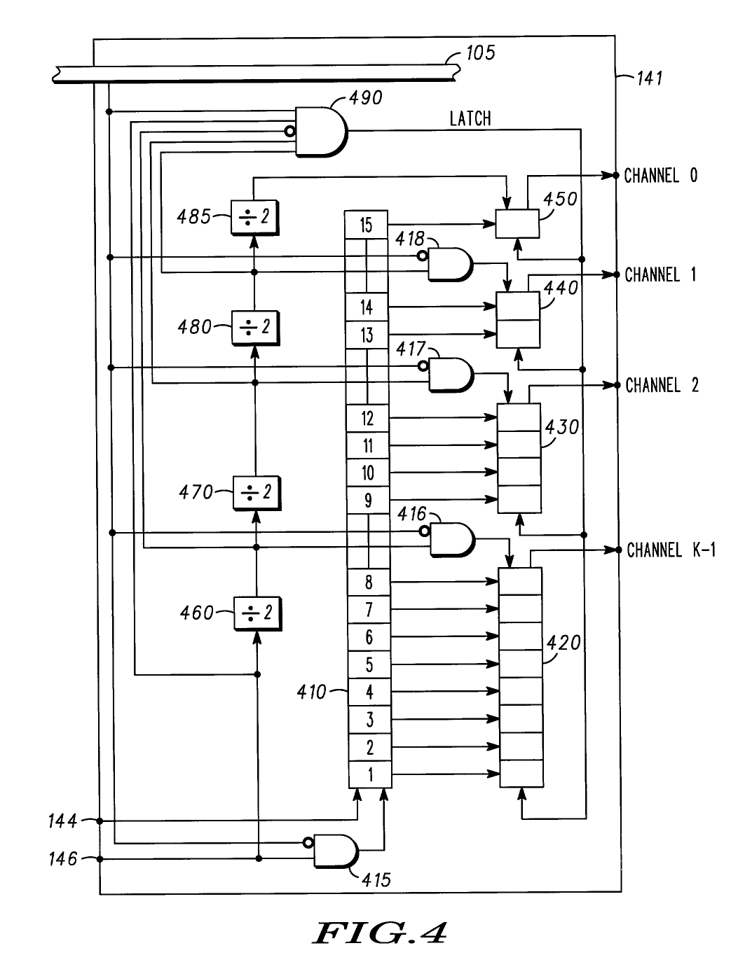

In FIG. 4 there is illustrated a schematic block diagram of the serial to parallel converter 141 that includes a 15 bit serial-in parallel-out shift register 410 with a data input coupled to the signal input 144 and a clock input coupled through an AND gate 415 to the input 146. Coupled to outputs of the first eight bits of the shift register 410 (bits 1 to 8) are respective parallel loadable inputs of a parallel-in serial-out shift register 420 that has a serial output for providing data to Channel K−1. Coupled to outputs of the next four bits of the shift register 410 (bits 9 to 12) are respective parallel loadable inputs of a parallel-in serial-out shift register 430 that has a serial output for providing data to Channel 2. The next two bits of the shift register 410 (bits 13 and 14) are coupled to respective parallel loadable inputs of a parallel-in serial-out shift register 440 that has a serial output for providing data to Channel 1. The last bit of the shift register 410 (bit 15) is coupled to a parallel loadable input of a parallel-in serial-out shift register 450 that has a serial output for providing data to Channel 0.

There is also cascaded divide by two circuitry comprising four divide by two modules 460,470,480,485. An input of divide by two module 460 is coupled directly to the input 146 with an output of module 460 coupled directly to an input of the divide by two module 470 and coupled through an AND gate 416 to a clock input of shift register 420. An output of the divide by two module 470 is coupled directly to an input of the divide by two module 480 and coupled through an AND gate 417 to a clock input of shift register 430. An output of the divide by two module 480 is coupled directly to an input of an AND gate 490 and coupled through an AND gate 418 to a clock input of shift register 440. The output of the module 480 is also coupled directly to an input of the divide by two module 485 and an output of the module 485 is coupled directly to a clock input of shift register 450.

The input 146 of the serial to parallel converter 141 and output of module 470 are also directly coupled to inputs of the AND gate 490. Further, the output of module 460 is coupled to an inverting input of AND gate 490. Another input to AND gate 490 is provided from bus 105 and the output of AND gate 490 provides a latch signal input to each latch input of the shift registers 420,430,440 and 450. In addition, the AND gates 415, 416, 417 and 418 have inverting inputs coupled to the bus 105.

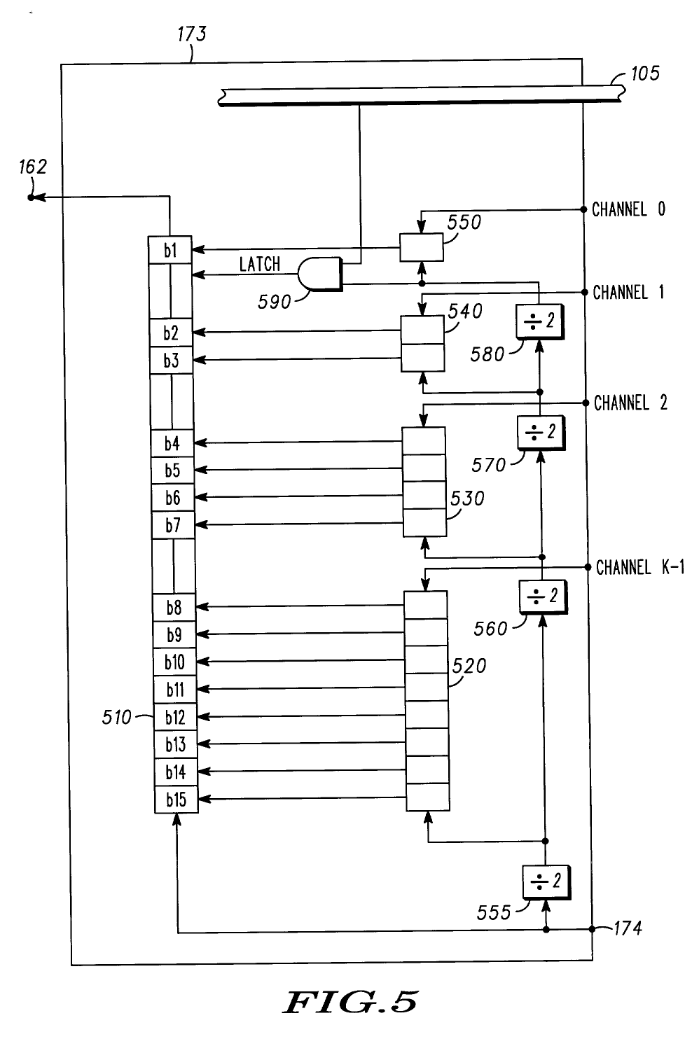

Referring to FIG. 5 there is illustrated a schematic block diagram of the parallel to serial converter 173 that includes a 15 bit parallel-in serial-out shift register 510 with a clock input coupled to the clock signal input 174 and a serial output coupled to the output 162. A serial-in parallel-out eight bit shift register 520 has a serial input coupled to the Channel K−1 input (K=4 for this embodiment). Coupled to respective outputs of the shift register 520 are parallel loadable inputs of the last eight bits shift register 510 (bits b15 to b8). There is also a serial-in parallel-out four bit shift register 530 with a serial input coupled to the Channel 2 input. Coupled to respective outputs of the shift register 530 are parallel loadable inputs of bits b4 to b7 of shift register 510. The parallel to serial converter 173 also has a serial-in parallel-out two bit shift register 540 with a serial input coupled to the Channel 1 input. Coupled to respective outputs of the shift register 540 are parallel loadable inputs of bits b2 to b3 of shift register 510. There is also a serial-in parallel-out one bit shift register 550 with a serial input coupled to the Channel 0 input. Coupled to an output of the shift register 550 is parallel loadable input of bit b1 of shift register 510.

The serial to parallel converter 173 has a cascaded divide by two circuitry comprising four divide by two modules 555,560,570,580. An input of divide by two module 555 is coupled directly to clock signal input 174 with an output coupled to both a clock input of shift register 520 and an input of the divide by two module 560. An output of the divide by two module 560 is coupled to both a clock input of shift register 530 and an input of the divide by two module 570. An output of the divide by two module 570 is coupled to both a clock input of shift register 540 and an input of the divide by two module 580. An output of the divide by two module 580 is coupled to both a clock input of shift register 550 and an input of an AND gate 590. Another input to AND gate 590 is provided from bus 105 and the output of AND gate 590 provides a latch signal input to a latch input of the shift register 510.

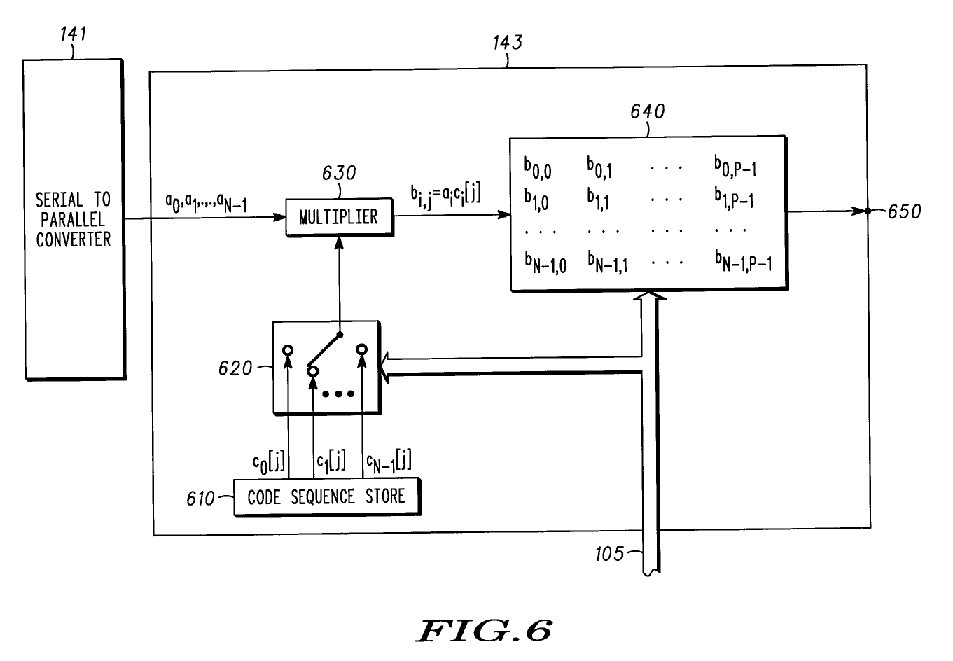

In FIG. 6 there is illustrated a block diagram of one of the sequence spreading modules 143 comprising a multiplier 630 with an input coupled to a channel output of the serial to parallel converter 141. There is also a code sequence store 610 that stores coded sequences C₀[j] to C_{N-1}[j] each of length P bits. Outputs of the code sequence store 610 are coupled to inputs of a switch 620 that is coupled to bus 105 and an output of switch 620 is coupled to an input of the multiplier 630. An output of the multiplier 630 is coupled to a row-in column-out memory array 640 that is coupled to the bus 105 and has an output 650.

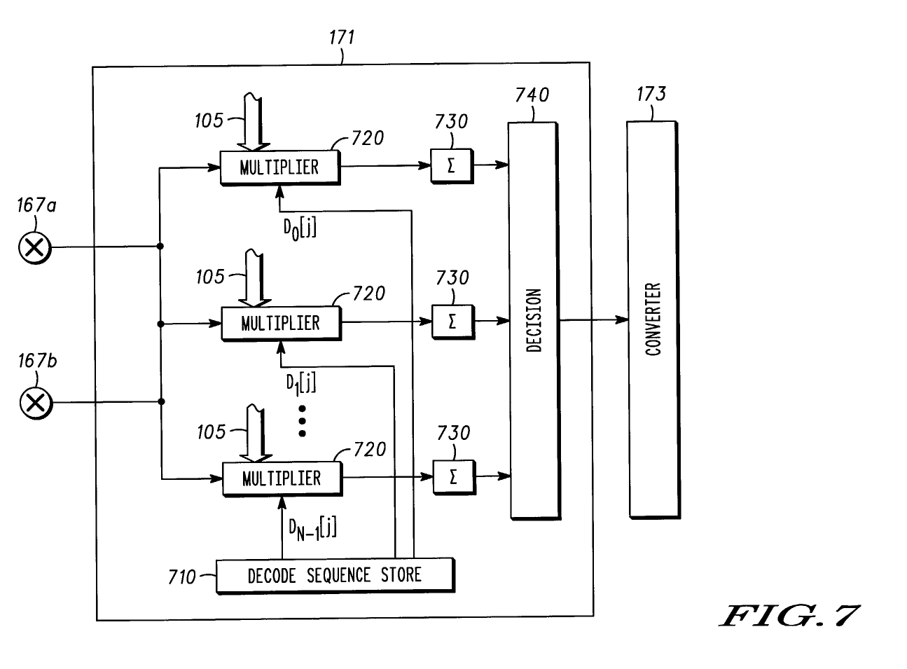

In FIG. 7 there is illustrated a block diagram of one of the sequence despreading modules 171 comprising a plurality of multipliers 720 with real and imaginary inputs respectively coupled to outputs of the real and imaginary demodulators 167a,167b. There is also a decode sequence store 710 that stores decode sequences D₀[j] to D_{N-1}[j] each of length P bits that is identical to the coded sequences C₀[j] to C_{N-1}[j]. Outputs of the decode sequence store 710 are respectively coupled to inputs of one of the multipliers 720 that are coupled to bus 105 and an output of each of the multipliers 720 is coupled to a respective integrator 730. An output of each integrator 730 is coupled to an input of a decision circuit 740 that has an output coupled an input of the parallel to the serial converter 173.

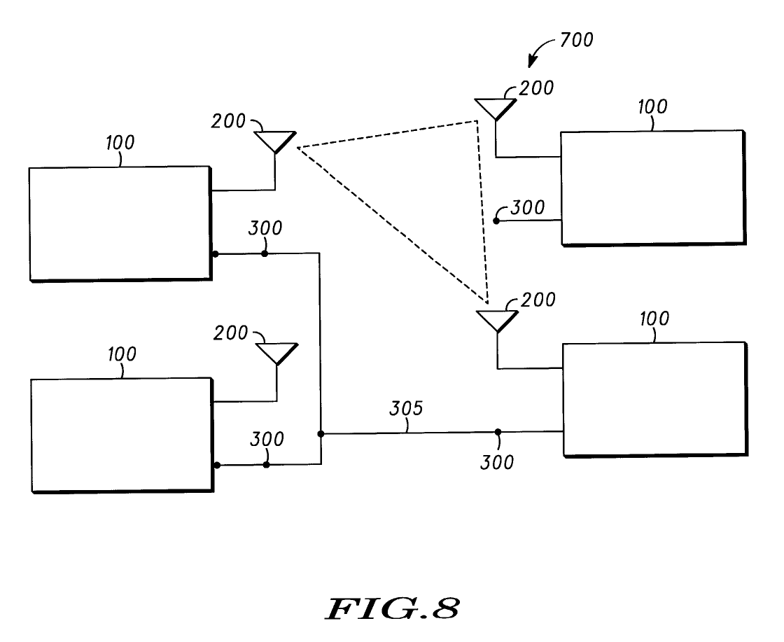

In FIG. 8 there is illustrated a schematic block diagram of a spread spectrum signal communication system 700 comprising a plurality of electronic devices 100 communicating with each other either by port nodes 300 coupled by the wired communication links 305 or by the antenna arrays 200 using radio waves.

Referring generally to FIGS. 1 to 8, the present invention operates such that the spread spectrum signal encoder 140 typically receives a serial data stream of bits a₀ to aₘ from the user interface 220. The serial to parallel converter 141 of the spectrum signal encoder 140 converts and distributes the serial data stream of bits a₀ to aₘ into a plurality of parallel data bit streams of different bit lengths provided to the respective Channels 0 to K−1. Every 16 clock cycles, at input 146, the serial to parallel converter 141 clocks the serial data stream of bits a₀ to aₘ into shift register 410. After the 16 clock cycles, that form a 16 clock cycle sequence, 15 bits of the data stream of bits a₀ to aₘ are clocked into shift register 410. During a 15th of the 16 clock cycles, the bus 105 sends a logic 1 pulse to its associated inputs of the AND gates 415, 416, 417, 418 and 490 thereby generating the latch signal and disabling the clock signal to registers 410,420,430,440 until near completion of the 16th clock cycle. As will be apparent to a person skilled in the art, the clock signal to register 450 will be in a steady state between the 15th and 16th clock signal transitions and there is no need to disable the clock signal to register 450.

The data stream of bits a₀ to aₘ is parallel loaded (latched) into respective bit locations of shift registers 420, 430, 440 and 450 every 15th clock cycle, of the 16 cycle sequence, after a steady state condition is achieved in shift register 410. During the next 15 of 16 clock cycles the data bits stored in registers 420,430,440,450 are serially shifted out thereby distributing the serial data stream of bits a₀ to aₘ as the parallel data bit streams of different bit lengths to the respective sequence spreading modules 143 via respective Channels 0 to K−1.

When one of the sequence spreading modules 143 receives a respective one of the parallel data bit streams, for example an incoming bit sequence a₀ to aN−1, from the serial to parallel converter 141, the switch 620 selectively supplies the code sequences C₀[j] to C_{N-1}[j] in store 610 to the multiplier 630. The multiplier 630 selectively multiplies each bit of the bit sequence a₀ to aN−1 with a different one of the code sequences C₀[j] to C_{N-1}[j]. This results in the multiplier 630 providing a product of a₁ and Cᵢ[j] and the incoming bit sequence a₀ to aN−1 of data bits is therefore expanded into a coded bit sequence b_{i,j}. The coded bit sequence b_{i,j} for each bit a₀ to aN−1 is stored row by row in the row-in column-out memory array 640. Accordingly, there are N rows of bits, each row having a length of P bits. It should be noted that ideally the code sequences C₀[j] to C_{N-1}[j] each have a bit code that is mutually orthogonal to other bit codes of the sequence spreading module 143 so that any pair of bit code sequences C₀[j] to C_{N-1}[j] have a cross correlation of zero. For example, if N=2 and P=4, a possible mutually orthogonal bit code sequence pair is C₀[j]={−1, −1, −1, +1} and C₁[j]={−1, +1, +1, +1}.

After the coded bit sequence b_{i,j} for the incomming bit sequence a₀ to aN−1 is stored in the row-in column-out memory array 640, the coded bit sequence b_{i,j} is serially provided to output 650 column by column. Accordingly, each coded bit of the coded bit sequence b_{i,j} is interleaved with other bits of the coded bit sequence b_{i,j} to provide an interleaved spread spectrum signal (ISSS).

The bit sequence length (number of bits) for each interleaved spread spectrum signal ISSS at each channel output 650 of the respective sequence spreading modules 143 is unique relative to bit sequence lengths for interleaved spread spectrum signal ISSS provided at the outputs 650 of all other sequence spreading modules.

Similar to the bit sequence length, the bit time period for each interleaved spread spectrum signal ISSS at each channel output 650 of the respective sequence spreading modules 143 is unique relative to bit time periods for interleaved spread spectrum signal ISSS provided at the outputs 650 of all other sequence spreading modules.

Typically, at the output 650 for Channel 0 there is provided an interleaved spread spectrum signal ISSS with a base bit time period To. All other interleaved spread spectrum signal ISSS for Channels 1 to K−1 have a base bit time period that is an integer multiple n of the base bit time period To, wherein Tk=Tₖ₋₁/n for any Channel 1 to K−1 and n is a positive integer. In this embodiment the integer n is chosen to be 2. This is because the parallel converted bit sequence a₀ to aN−1 for each Channel 0 to K−1 increases in length by a multiple of 2. For instance, for every bit provided at Channel 0 by the serial to parallel converter, two bits will be provided at Channel 1 and four bits will be provided at Channel 2. Thus the product of the bit sequence length and bit time period for each of the Channels 0 to K−1 is equal.

The interleaved spread spectrum signal ISSS for Channels 0 to K−1 are each modulated by their unique carrier frequency and then combined by combiner 149 to provide a multi-carrier spread spectrum signal (MSSS) to the output unit 150. The output unit 150 transmits the multi-carrier spread spectrum signal MSSS by the wired communication links 305 or by radio waves linked by the antenna arrays 200.

The electronic device 100 can also receive a multi-carrier spread spectrum signal MSSS via the wired communication links 305 or by radio waves linked by the antenna arrays 200. A received multi-carrier spread spectrum signal MSSS is amplified by the input unit 155 and sent to the spread spectrum signal decoder 160.

The band pass filters 161 of the spectrum signal decoder 160 filter the received multi-carrier spread spectrum signal MSSS to select the modulated interleaved spread spectrum signal ISSS for respective Channels 0 to K−1. Each interleaved spread spectrum signal ISSS is demodulated by respective IQ demodulators 108, whereby synchronization with the received multi-carrier spread spectrum signal MSSS is effectively achieved by use of the automatic frequency controller 169 and oscillator 166 as will be apparent to a person skilled in the art. Real and imaginary components of each demodulated interleaved spread spectrum signal ISSS associated with one of the Channels 0 to K−1 are processed by a respective despreading module 171. The multipliers 105 of each despreading module 171 multiplies the real and imaginary components of the interleaved spread spectrum signal ISSS with the respective decode sequences D₀[j] to D_{N-1}[j] of length P bits stored in decode sequence store 710. The resulting bit sequences at outputs of each of the multipliers are integrated by integrators 730 to provide decoded bit values and then decision circuit 640 compares the decoded bit values against a threshold to provide a decoded bit sequence for one of channels 0 to K−1. All the decoded bit sequences are combined into a decoded bit stream by converter 173 and then stored in data store 175 for subsequent sending to user interface 220 or processing by processor 190.

Advantageously, the present invention provides a multi-carrier spread spectrum signal, with unique carrier frequencies relative to all other carrier frequencies of the electronic device 100. Accordingly, suitable bandwidths of these carrier frequencies can be selected so that the possibility of interference with existing narrowband systems is reduced.

The present invention also allows for digital signal processing of received signals. This is allowable because the despreading module provides a baseband signal from the received multi-carrier spread spectrum signal. This baseband signal can be processed digitally therefore cross-correlation can be effected digitally instead of by an analogue device. Further, if any pair of bit code sequences C₀[j] to C_{N-1}[j] have a cross correlation of zero, multi-path reflections can be substantially reduced.

Although the invention has been described with reference to a preferred embodiment it is to be understood that the invention is not restricted to the particular embodiment described herein. For example, the serial to parallel converter 141 and parallel to serial converter 173 can be implemented in software.

We claim:

1. An electronic device for providing a multi-carrier spread spectrum signal, the device comprising:
a serial to parallel converter;
a plurality sequence spreading modules each with an input coupled to a respective output of said serial to parallel converter;
a plurality of modulators each being coupled to an output of a respective one of said sequence spreading modules and each of said modulators having a unique carrier frequency relative to all other carrier frequencies of the other said modulators; and
an output unit coupled to said modulators, wherein, in use, said serial to parallel converter converts a received serial data stream of bits into a plurality of parallel data bit streams of different bit lengths, and said sequence spreading modules expand a received one of said parallel data bit streams into a coded bit sequence, and wherein said coded bit sequence from each of said sequence spreading modules have a unique time period relative to said coded bit sequence from every other of said sequence spreading modules.

2. An electronic device, as claimed in claim 1, further including a combiner coupling said modulators to said output unit, said combiner having inputs coupled to a respective output of each of said modulators,
wherein an output of said combiner provides the multi-carrier spread spectrum signal that is a combination of the coded bit sequence.

3. An electronic device, as claimed in claim 1, wherein each of said sequence spreading modules codes a plurality of consecutively received said data bits of a respective one of said parallel data bit streams into an interleaved spread spectrum signal.

4. An electronic device, as claimed in claim 3, wherein each of the sequence spreading modules codes the consecutively received data bits by a code sequence having a bit code associated with each of the received data bits, wherein any bit code pair of the coded sequence when cross correlated is zero.

5. An electronic device, as claimed in claim 1, wherein each of the sequence spreading modules provides a bit time period that is unique relative to bit time periods provided by the other sequence spreading modules.

6. An electronic device, as claimed in claim 3, wherein each of the sequence spreading modules provides a bit time period that is unique relative to bit time periods provided by the other sequence spreading modules.

7. An electronic device, as claimed in claim 1, wherein one of the sequence spreading modules provides a base bit time period and wherein all the other sequence spreading modules provide a bit time period that is an integer multiple of the base time period.

8. An electronic device, as claimed in claim 3, wherein each said interleaved spread spectrum signal from each of said sequence spreading modules has a unique number of bits relative to the interleaved spread spectrum signal from the other sequence spreading modules and wherein the number of unique bits multiplied by the associated bit time period for each of the sequence spreading modules results in identical coded sequence time durations.

9. An electronic device, as claimed in claim 3, further including an input unit coupled to a spectrum signal decoder, wherein the spectrum signal decoder decodes a received multi-carrier spread spectrum signals received at the input unit to provide a decoded bit stream.

10. An electronic device, as claimed in claim 9, wherein the decoder includes:
a plurality of demodulators each coupled to respective despreading modules, and wherein, in use, said despreading modules decode the received multi-carrier spread spectrum signals into the decoded bit stream.

11. An electronic device, as claimed in claim 10, wherein the spectrum signal decoder includes a parallel to serial converter coupled to respective outputs of the despreading modules.

12. An electronic device, as claimed in claim 1, wherein the output unit includes a radio transmitter.

13. A multi-carrier spread spectrum signal communication system comprising:
a communication link; and a plurality of electronic devices in communication with each other by the communication link, the electronic devices comprising:
a serial to parallel converter;
a plurality sequence spreading modules each with an input coupled to a respective output of said serial to parallel converter;
a plurality of modulators each being coupled to an output of a respective one of said sequence spreading modules and each of said modulators having a unique carrier frequency relative to all other carrier frequencies of the other said modulators; and
an output unit coupled to said modulators, wherein, in use, said serial to parallel converter converts a received serial data stream of bits into a plurality of parallel data bit streams of different bit lengths, and said sequence spreading modules expand a received one of said parallel data bit streams into a coded bit sequence, and wherein said coded bit sequence from each of said sequence spreading modules have a unique time period relative to said coded bit sequence from every other of said sequence spreading modules.

14. A multi-carrier spread spectrum signal communication system, as claimed in claim 13, further including a combiner coupling said modulators to said output unit, said combiner having inputs coupled to a respective output of each of said modulators,
wherein an output of said combiner provides the multi-carrier spread spectrum signal that is a combination of the coded bit sequence.

15. A multi-carrier spread spectrum signal communication system, as claimed in claim 13, wherein each of said sequence spreading modules codes a plurality of consecutively received said data bits of a respective one of said parallel data bit streams into an interleaved spread spectrum signal.

16. A multi-carrier spread spectrum signal communication system, as claimed in claim 15, wherein each of the sequence spreading modules codes the consecutively received data bits by a code sequence having a bit code associated with each of the received data bits, wherein any bit code pair of the coded sequence when cross correlated is zero.

17. A multi-carrier spread spectrum signal communication system, as claimed in claim 13, wherein each of the sequence spreading modules provides a bit time period that is unique relative to bit time periods provided by the other sequence spreading modules.

18. A multi-carrier spread spectrum signal communication system, as claimed in claim 15, wherein each of the sequence spreading modules provides a bit time period that is unique relative to bit time periods provided by the other sequence spreading modules.

19. A multi-carrier spread spectrum signal communication system, as claimed in claim 13, wherein one of the sequence spreading modules provides a base bit time period and wherein all the other sequence spreading modules provide a bit time period that is an integer multiple of the base time period.

20. A multi-carrier spread spectrum signal communication system, as claimed in claim 15, wherein each said interleaved spread spectrum signal from each of said sequence spreading modules has a unique number of bits relative to the interleaved spread spectrum signal from the other sequence spreading modules and wherein the number of unique bits multiplied by the associated bit time period for each of the sequence spreading modules results in identical coded sequence time durations.

21. A multi-carrier spread spectrum signal communication system, as claimed in claim 15, further including an input unit coupled to a spectrum signal decoder, wherein the spectrum signal decoder decodes a received multi-carrier spread spectrum signals received at the input unit to provide a decoded bit stream.

22. A multi-carrier spread spectrum signal communication system, as claimed in claim 21, wherein the decoder includes:
a plurality of demodulators each coupled to respective dispreading modules, and wherein, in use, said despreading modules decode the received multi-carrier spread spectrum signals into the decoded bit stream.

23. A multi-carrier spread spectrum signal communication system, as claimed in claim 22, wherein the spectrum signal decoder includes a parallel to serial converter coupled to respective outputs of the despreading modules.

24. A multi-carrier spread spectrum signal communication system, as claimed in claim 13, wherein the output unit includes a radio transmitter.
